(19) United States
(12) Patent Application Publication
(10) Pub. No.: US 2006/0095907 A1
(43) Pub. Date: May 4, 2006

(54) Apparatus and method for autonomic problem isolation for a software application

(75) Inventors: Eric Lawrence Barsness, Pine Island, MN (US); Curtis Duane Kronlund, Farmington, MN (US); Scott Alan Moore, Rochester, MN (US); Gregory Allan Olson, Rochester, MN (US)

Correspondence Address: MARTIN & ASSOCIATES, LLC, P.O. BOX 548, CARTHAGE, MO, 64836-0548, US

(73) Assignee: INTERNATIONAL BUSINESS MACHINES CORPORATION, ARMONK, NY (US)

(21) Appl. No.: 10/977,802

(22) Filed: Oct. 29, 2004

(51) Int. Cl. G06F 9/46

(52) U.S. Cl. 718/100

(57) ABSTRACT

A method and apparatus autonomically analyze computer software performance to identify performance problems and isolate particular pieces of software that contribute to those performance problems to improve overall computer system performance. In preferred embodiments, performance problems are identified based on information learned from running an application, and instrumentation hooks are dynamically inserted at instrumentation points to isolate the performance problems.

### BACKGROUND OF THE INVENTION

1. Technical Field

This invention generally relates to computer systems, and more specifically relates to tools for monitoring performance and troubleshooting computer software systems.

2. Background Art

Modern computer data systems often manage extremely large amounts of data that are accessed by a variety of software applications simultaneously. The computer system's performance in processing data is usually extremely critical for the users. The users may be part of a large corporate or government entity with many users. The loss of system performance will have a negative impact on employee productivity and customer satisfaction. When the performance of the computer system became unsatisfactory, the prior art required trained software experts to troubleshoot the computer's performance. The computer expert could use various tools to probe the software's performance in a manual, intensive way that was typically quite intrusive, meaning the analysis process would further impact performance.

One type of tool for monitoring and managing computer performance is a work load manager (WLM). The WLM can be programmed to learn about the delays that occur, and allocate resources to reduce response times. For example, an administrator can set a performance goal such as “web requests to send a response back within four seconds” and the WLM algorithms then determine the best configuration to satisfy those goals.

The prior art tools for analyzing computer system performance, including tools such as the WLM, are not effective in isolating problems to a small piece of code. For example, the tool may only determine what type of operation is consuming the system resources, but not which routine. Or the computer expert would have to manually look over large dumps of raw data to try to determine what was happening when the computer's performance was degraded. The prior art tools also not effective in finding some types of problems such as “hiccups,” which are problems that may occur infrequently or unpredictably; or slow degradation of system performance.

Without a more effective way to analyze and improve system performance, the computer industry will continue to suffer from excessive costs due to poor computer system performance.

### DISCLOSURE OF INVENTION

A method and apparatus autonomically analyze computer software performance to identify performance problems and isolate particular pieces of software that contribute to those performance problems to improve overall computer system performance. In preferred embodiments, performance problems are identified based on information learned from running an application, and instrumentation hooks are dynamically inserted at instrumentation points to isolate the performance problems. The present invention is particularly advantageous for transaction oriented applications.

The foregoing and other features and advantages of the invention will be apparent from the following more particular description of preferred embodiments of the invention, as illustrated in the accompanying drawings.

### BRIEF DESCRIPTION OF DRAWINGS

The preferred embodiments of the present invention will hereinafter be described in conjunction with the appended drawings, where like designations denote like elements, and:

FIG. 1 is a block diagram of an apparatus in accordance with the preferred embodiments;

FIG. 2 is a flow diagram of a specific method in accordance with the preferred embodiments for initializing a computer system to autonomically identify and isolate performance problems;

FIG. 3 is a flow diagram of another specific method in accordance with the preferred embodiments for autonomically identifying and isolating performance problems in a computer system; and

FIG. 4 is a diagram of a specific example in accordance with the preferred embodiments to autonomically identify and isolate performance problems.

### BEST MODE FOR CARRYING OUT THE INVENTION

The present invention provides a method and apparatus to autonomically analyze computer software performance and isolate particular pieces of software that contribute to those performance problems. The present invention is described in terms of functions performed by a workload manager. The features of the present invention are described as combined with the features of the prior art work load manager, but those skilled in the art will recognize that the present invention could also be implemented in a stand-alone performance tool having the described features.

Embodiments provide a method and apparatus to autonomically analyze computer software performance to identify performance problems and isolate particular transactions or pieces of software that contribute to those performance problems to improve overall computer system performance. As used herein, a workload manager (WLM) is a system such as the prior art WLM described in the background that further includes the inventive features described herein. In preferred embodiments, the WLM uses ARM ( The Open Group's Application Response Measurement) transaction API (application program interface) calls to set hooks at instrumentation points. This is done via the API calls arm_transaction_start( ) and arm_transaction_stop( ). Other methods for setting hooks for instrumentation could be used such as program calls, or any other means for instrumentation currently known or developed in the future. The term transaction is used herein in the same way as set forth in the ARM instrumentation standard. Thus a “transaction” can be any piece of code an application developer wants to define as a transaction. A unit of work is a transaction, a servelet call, a database transaction, or any other division of the software defined by the user. A sub-transaction and a sub-unit of work are divided portions of a transaction and a unit of work respectively.

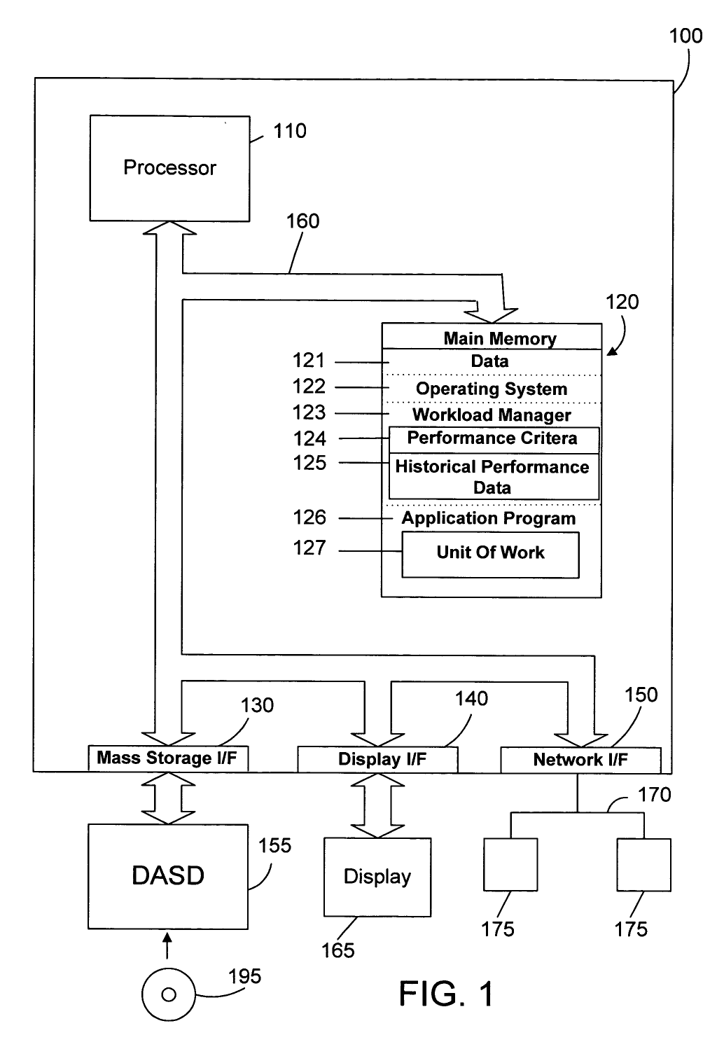

Referring to FIG. 1, a computer system 100 is one suitable implementation of an apparatus in accordance with the preferred embodiments of the invention. Computer system 100 is an IBM eServer iSeries computer system. However, those skilled in the art will appreciate that the mechanisms and apparatus of the present invention apply equally to any computer system, regardless of whether the computer system is a complicated multi-user computing apparatus, a single user workstation, or an embedded control system. As shown in FIG. 1, computer system 100 comprises a processor 110, a main memory 120, a mass storage interface 130, a display interface 140, and a network interface 150. These system components are interconnected through the use of a system bus 160. Mass storage interface 130 is used to connect mass storage devices, such as a direct access storage device 155, to computer system 100. One specific type of direct access storage device 155 is a readable and writable CD RW drive, which may store data to and read data from a CD RW 195.

Main memory 120 in accordance with the preferred embodiments contains data 121, an operating system 122, a workload manager 123, and an application program 126. Data 121 represents any data that serves as input to or output from any program in computer system 100. Operating system 122 is a multitasking operating system known in the industry as OS/400; however, those skilled in the art will appreciate that the spirit and scope of the present invention is not limited to any one operating system. The workload manager 123 is similar to IBM's Enterprise Workload Manager (EWLM) but is enhanced with the features of the preferred embodiments described herein. The application program 126 represents one of many application programs that may be running on the system. A unit of work 127 is a transaction, a servelet call, a database transaction, or any other division of the software defined by the user. WLM 123 and the interaction of the WLM 123 with the application program are described further below.

Computer system 100 utilizes well known virtual addressing mechanisms that allow the programs of computer system 100 to behave as if they only have access to a large, single storage entity instead of access to multiple, smaller storage entities such as main memory 120 and DASD device 155. Therefore, while data 121, operating system 122, workload manager 123, and application program 126 are shown to reside in main memory 120, those skilled in the art will recognize that these items are not necessarily all completely contained in main memory 120 at the same time. It should also be noted that the term “memory” is used herein to generically refer to the entire virtual memory of computer system 100, and may include the virtual memory of other computer systems coupled to computer system 100.

Processor 110 may be constructed from one or more microprocessors and/or integrated circuits. Processor 110 executes program instructions stored in main memory 120. Main memory 120 stores programs and data that processor 110 may access. When computer system 100 starts up, processor 110 initially executes the program instructions that make up operating system 122. Operating system 122 is a sophisticated program that manages the resources of computer system 100. Some of these resources are processor 110, main memory 120, mass storage interface 130, display interface 140, network interface 150, and system bus 160.

Although computer system 100 is shown to contain only a single processor and a single system bus, those skilled in the art will appreciate that the present invention may be practiced using a computer system that has multiple processors and/or multiple buses. In addition, the interfaces that are used in the preferred embodiment each include separate, fully programmed microprocessors that are used to off-load compute-intensive processing from processor 110. However, those skilled in the art will appreciate that the present invention applies equally to computer systems that simply use I/O adapters to perform similar functions.

Display interface 140 is used to directly connect one or more displays 165 to computer system 100. These displays 165, which may be non-intelligent (i.e., dumb) terminals or fully programmable workstations, are used to allow system administrators and users to communicate with computer system 100. Note, however, that while display interface 140 is provided to support communication with one or more displays 165, computer system 100 does not necessarily require a display 165, because all needed interaction with users and other processes may occur via network interface 150.

Network interface 150 is used to connect other computer systems and/or workstations (e.g., 175 in FIG. 1) to computer system 100 across a network 170. The present invention applies equally no matter how computer system 100 may be connected to other computer systems and/or workstations, regardless of whether the network connection 170 is made using present-day analog and/or digital techniques or via some networking mechanism of the future. In addition, many different network protocols can be used to implement a network. These protocols are specialized computer programs that allow computers to communicate across network 170. TCP/IP (Transmission Control Protocol/Internet Protocol) is an example of a suitable network protocol. The database described above may be distributed across the network, and may not reside in the same place as the application software accessing the database. In a preferred embodiment, the database primarily resides in a host computer and is accessed by remote computers on the network which are running an application with an internet type browser interface over the network to access the database.

At this point, it is important to note that while the present invention has been and will continue to be described in the context of a fully functional computer system, those skilled in the art will appreciate that the present invention is capable of being distributed as a program product in a variety of forms, and that the present invention applies equally regardless of the particular type of computer-readable signal bearing media used to actually carry out the distribution. Examples of suitable computer-readable signal bearing media include: recordable type media such as floppy disks and CD RW (e.g., 195 of FIG. 1), and transmission type media such as digital and analog communications links.

Again referring to FIG. 1, computer system 100 is shown with a workload manager 123 in memory 120 in accordance with preferred embodiments of the invention. In the remainder of this specification, the term “WLM” is used to refer to the workload manager 123 of the preferred embodiments. The WLM 123 autonomically analyzes computer software performance to identify performance problems and isolates the problems to particular transactions or portions of a transaction referred to as sub-transactions herein. The present invention uses dynamic insertion of performance hooks to identify and isolate performance problems by placing and moving performance instrumentation points dynamically based on information learned from executing an application. The identification and isolation functions are described further below.

As described above, the prior art work load managers allowed the user to select performance goals for certain transactions. The WLM would then adjust system resources to attempt to maintain performance within those goals. When a system using the WLM fails to meet the goals, it is often a complicated process to determine the cause of the poor performance. In addition to the performance goals of the prior art, the present invention uses performance criteria 124 and historical performance data 125 to assist in determining when a problem exists.

In the preferred embodiments, performance criteria 124 is obtained from a system administrator to configure the WLM to be able to determine a performance problem exists. The performance criteria may be the same as the performance goals in the prior art. The performance criteria 124 could also include criteria such as the resolution for performance monitoring. The performance criteria 124 includes performance heuristics to set trigger points that define a performance problem in relation to the historical performance data—i.e. a trigger point of 10% above historical performance indicates a problem sufficient to start isolation. The performance criteria could allow for different historical percentages for the trigger point for different scenarios. For example, a different trigger point percentage of historical performance for a “hiccup” from a slow degradation type of performance. The performance criteria may also include a resolution for performance monitoring that determines the size or boundaries of the transactions to monitor. The performance criteria may also include the types of code, or procedure calls that are the boundaries for performance monitoring, and the timing for how often the performance monitor will be invoked to check performance.

In preferred embodiments, the WLM has an initialization stage that runs under control of the system administrator. The initialization stage will obtain the system goals as described in the prior art, and the performance criteria 124 as described above. The initialization stage in the preferred embodiments also will get an initial set of historical performance data 125. This historical performance data 125 is used in combination with the performance criteria 124 to determine when a performance problem exists.

After the initialization stage, the WLM periodically monitors the performance of the system. The WLM may check performance at regular intervals set in the performance criteria, at intervals set by an administrator, manually initiated by an administrator, or by other means to set the intervals. The current performance is measured by the WLM and compared to the historical performance data to determine when a performance problem exits.

When the current performance varies with this historical performance data in an amount or degree stipulated in the performance criteria, then a performance problem has been identified. A performance problem could be identified by noticing that the transaction's average response time is increasing by an indicated amount in the performance criteria 124. Also, a performance problem could be identified by noticing that an individual transaction exceeds the average transaction response time by a sizable amount to identify unpredictable or large variations in response. Note that the WLM may complicate this process since it varies system resources based on the goals. The allocation of resources will need to be accounted for in the measurements for transaction performance.

When a performance problem has been identified, the WLM begins a process to isolate the problem to a specific transaction, and a sub-transaction. A first method for the isolation process is to calculate the number of instructions in the task between the API calls to start the transaction monitoring and stop the transaction monitoring. The WLM then breaks up the transaction by inserting another API call to signify a mid-transaction instrumentation point. The next time the WLM detects a performance problem on this the WLM will be able to collect data for the two parts of the transaction and split the performance goals accordingly. This will enable the WLM to determine which half of the transaction the problem resides in. This process can be repeated until a predetermined level of assurance is met that the location of the problem has been determined. The predetermined level of assurance can be set in the performance criteria 124 to indicate when the isolation process is done dividing the transaction. In a variation of this method, the transaction could be broken up into several sections and the performance monitored for each of the sections with the corresponding split of the original performance goal.

Another way to perform the isolation process is to split the transaction by the number of method calls and insert hooks at instrumentation points as described above. Other methods of dividing the transactions and heuristics could also be used and are contemplated by embodiments of the present invention herein.

The WLM continues to divide or split the transaction or unit of work until it is done dividing. The WLM is done dividing the transaction when it reaches a limit to the routines ability to divide the transaction, or it reaches a predetermined limit such as a limit set in the performance criteria. The performance criteria described above could include a resolution or granularity to indicate to the WLM that dividing the transaction is complete when the limit is reached.

The WLM can be effective in isolating performance problems that were particularly problematic for prior art tools. A slow degradation in performance is more readily detected since the current performance is being compared to historical performance data, including data that was gathered at an initialization stage. The WLM described herein can also be effective for detecting an intermittent performance problem or hiccup. Where performance criteria can be specified so the WLM will detect the hiccup's poor performance, the isolation process will be able to divide the transaction with poor performance into sub-transactions. Upon the next occurrence of the hiccup, the WLM will be able to further isolate the problem by collecting data using the instrumentation hooks dynamically added on the previous iteration.

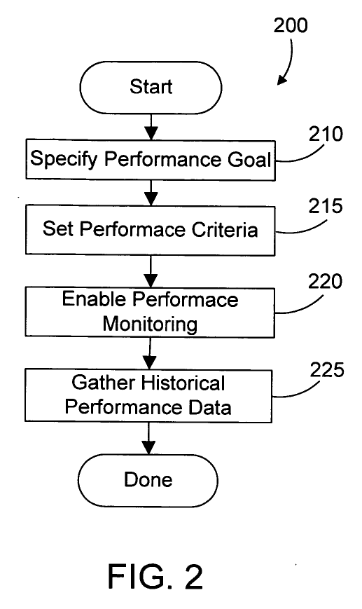

A method 200 in FIG. 2 shows the steps to initialize a workload manager according to an embodiment of the present invention. Method 200 first allows the user to specify performance goals (step 210). Then the user specifies performance criteria (step 215). The user is then allowed to enable or disable performance monitoring (step 220). An initial set of performance data is then gathered and stored for future reference (step 225) according to the performance criteria set up in step 210. The initialization stage is then done.

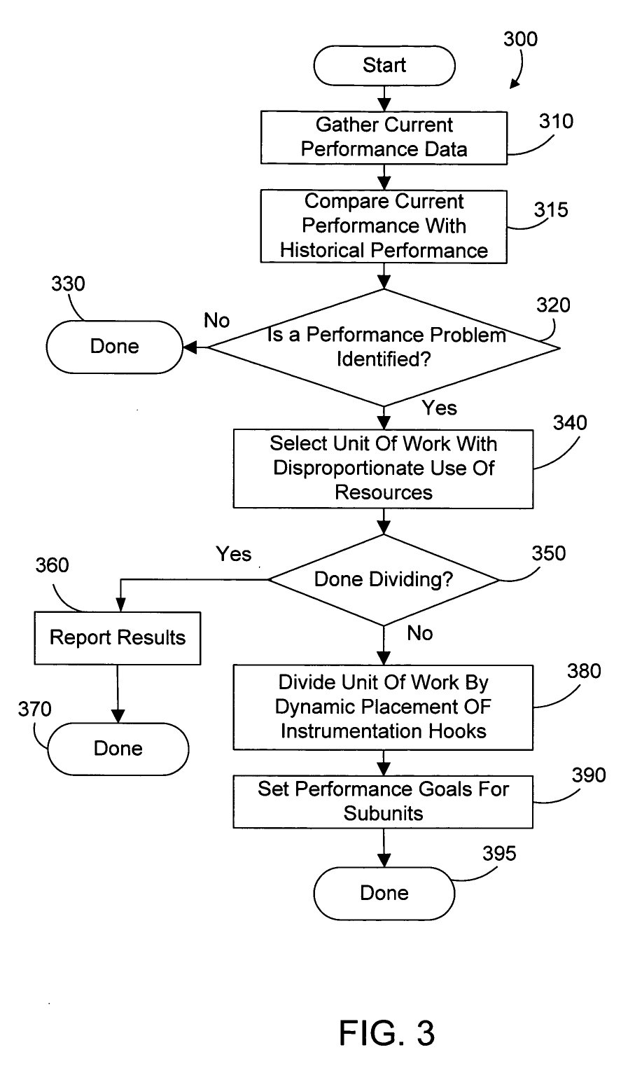

A method 300 in FIG. 3 shows the steps of the workload manager to identify and isolate a performance problem according to an embodiment of the present invention. Method 300 first gathers current performance data (step 310). The method 300 then compares the current performance with the historical performance (step 315). If a performance problem is not identified (step 320=no) then the method is done (step 330). If a performance problem is identified (step 320=yes) then the method proceeds to the problem isolation process beginning at step 340.

The isolation process of method 300 is a reiterative process to divide the transaction or unit of work to determine a smaller portion of the code of the application's software that is using a disproportionate amount of the system resources. This process is accomplished by multiple passes through method 300. Method 300 is invoked periodically to check the systems current performance with historical performance. In preferred embodiments, method 300 is invoked periodically according to a period set in the performance criteria 124 by an administrator. The isolation process first selects the unit of work (step 340). The method 300 then determines if it is done dividing the unit of work into sub-units (step 350). If it is done dividing (step 350=yes) then method 300 reports the results (step 360) of isolating the performance error and is done (step 370). If method 300 is not done dividing (step 350=no) then it divides the unit of work into multiple units of work (step 380) and sets performance goals (step 390) for each of the divided units of work from step 380. The method 300 is then done (step 395) with this iteration. The method then waits to be invoked again to collect additional performance data on the newly divided units of work.

Again referring to FIG. 3 the step for reporting the results (step 360) of isolating the performance error can take on different forms. The reporting may simply include logging in the location of the sub-transaction or sub-unit of code that was found to be a performance problem and waiting for an administrator to access the system to examine the results. In further embodiments the reporting step may include sending a message to the system administrator and/or the application provider that includes information on the isolated performance problem.

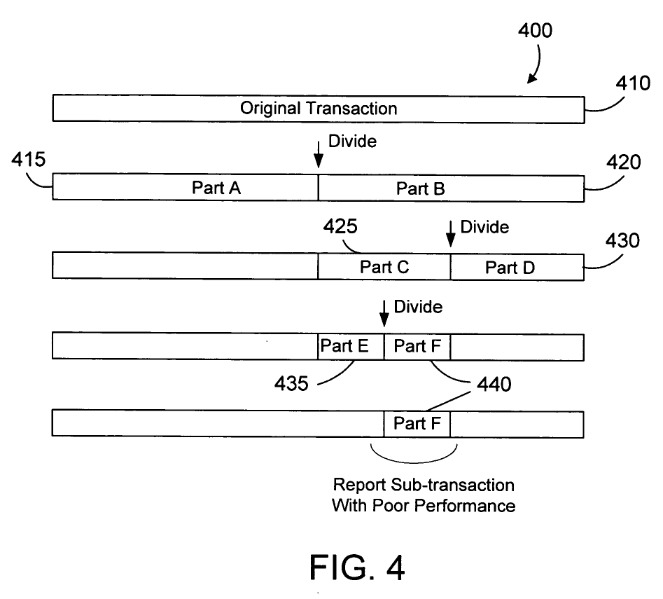

FIG. 4 illustrates an example of an iterative approach to isolate a portion of a transaction according to a preferred embodiment. An original transaction 410 is identified as a performance problem according to the performance criteria 124 when compared to historical performance data 125. In this embodiment, the performance problem is further isolated with a binary search by dividing the original transaction 410 into two sub-transactions. On the first iteration of the isolate process the transaction is divided into Part A and Part B (415 and 420 respectively). When a problem is again detected, the isolation process determines that the performance problem lies in Part B (420). Part B is then divided into two sub-transactions Part C and Part D (425 and 430 respectively). When a problem is again detected, the isolation process determines that the performance problem lies in Part C (425). Part C is then divided into two sub-transactions Part E and Part F (435 and 440 respectively). When a problem is again detected the isolation process determines that the performance problem lies in Part F (440). The isolation process then determines that it is done dividing as described above, and reports the results 450 as sub-transaction Part F (440). Similarly, in other embodiments, the original transaction 410 is divided into three or more sub-transactions.

The present invention as described with reference to the preferred embodiments herein provides significant improvements over the prior art. In preferred embodiments the workload manager autonomically identifies and isolates performance problems in the computer system's software. The present invention provides a way to improve system performance, particularly in large data system environments where a large number of computer software applications access the data and make it difficult to determine the source of the performance problem.

One skilled in the art will appreciate that many variations are possible within the scope of the present invention. Thus, while the invention has been particularly shown and described with reference to preferred embodiments thereof, it will be understood by those skilled in the art that these and other changes in form and details may be made therein without departing from the spirit and scope of the invention.

What is claimed is:

1. An apparatus comprising:
at least one processor;
a memory coupled to the at least one processor having at least one application program executed by the at least one processor; and
a workload manager that identifies a performance problem in executing a selected application program based on historical performance determined from at least one previous execution of the selected application program and isolates the performance problem by dynamically placing at least one instrumentation hook in the selected application program.

2. The apparatus of claim 1 wherein the workload manager isolates the performance problem by dividing a unit of work in the selected application program that uses a disproportionate amount of system resources into a plurality of sub-units and then analyzes the performance of the plurality of sub-units.

3. The apparatus of claim 2 wherein the workload manager further isolates the performance problem using an iterative process to divide a sub-unit of work that uses a disproportionate amount of system resources into a plurality of sub-units and then analyzes the performance of the plurality of sub-units.

4. The apparatus of claim 2 wherein the unit of work is a transaction with API calls to set the bounds of the transaction.

5. The apparatus of claim 2 wherein the disproportionate amount of resources is determined by comparing current use of resources with the historical performance.

6. The apparatus of claim 2 wherein the disproportionate amount of resources is determined by comparing the current use of resources with a historical performance and a threshold set by a system administrator.

7. The apparatus of claim 1 wherein the workload manager identifies the performance problem by comparing current performance with the predetermined threshold.

8. The apparatus of claim 1 wherein the workload manager identifies the performance problem by comparing current performance with a previous performance and an established comparison threshold.

9. The apparatus of claim 1 wherein the workload manager further notifies a software system provider that a provided software application is causing performance problems in a client computer system.

10. An apparatus comprising:
at least one processor;
a memory coupled to the at least one processor having at least one application program executed by the at least one processor;
a workload manager that identifies performance problems in executing a selected application program based on historical performance determined from at least one previous execution of the selected at least one application program, and isolates the performance problem by dynamically placing at least one instrumentation hook in the selected application program;
wherein the workload manager isolates the performance problem using an iterative process to divide a unit of work in the selected application program that uses a disproportionate amount of system resources into a plurality of sub-units, inserts at least one instrumentation hook in a selected sub-unit and then analyzes the performance of the plurality of sub-units to determine which sub-unit uses a disproportionate amount of system resources.

11. A method for monitoring performance of a computer system, the method comprising the steps of:
identifying a performance problem in executing a selected application program based on historical performance determined from at least one previous execution of the selected application program, and
isolating the performance problem by dynamically placing at least one instrumentation hook in the selected application program.

12. The method of claim 11 wherein the workload manager isolates the performance problem by dividing a unit of work in the selected application program that uses a disproportionate amount of system resources into a plurality of sub-units and then analyzes the performance of the plurality of sub-units.

13. The method of claim 13 wherein the workload manager further isolates the performance problem using an iterative process to divide a sub-unit of work that uses a disproportionate amount of system resources into a plurality of sub-units and then analyzes the performance of the plurality of sub-units.

14. The method of claim 12 wherein the unit of work is a transaction with API calls for the performance instrumentation points to set the bounds of the transaction.

15. The method of claim 11 wherein the disproportionate amount of resources is determined by comparing current use of resources with the historical performance.

16. The method of claim 11 wherein the disproportionate amount of resources is determined by comparing current use of resources with the historical performance and a threshold set by a system administrator.

17. The method of claim 11 wherein the workload manager identifies the performance problem by comparing current performance with a predetermined threshold.

18. The method of claim 11 wherein the workload manager identifies the performance problem by comparing current performance with a previous performance and an established comparison threshold.

19. The method of claim 11 wherein the workload manager further notifies a software system provider that a provided software application is causing performance problems in a client computer system.

20. A method for monitoring performance of a computer system, the method comprising the steps of:
identifying a performance problem in executing a selected application program based on historical performance determined from at least one previous execution of the selected at least one application program, and
isolating the performance problem by dynamically placing at least one instrumentation hook in the selected application program and using an iterative process to divide a unit of work in the selected application program that uses a disproportionate amount of system resources into a plurality of sub-units and then analyze the performance of the sub-units of work by placing at least one instrumentation hook in the plurality of sub-units to determine the unit of work to divide on the next iteration.

21. A program product comprising:
(A) a workload manager comprising:
a process for identifying a performance problem in executing a selected application program based on historical performance determined from at least one previous execution of the selected at least one application program;
a process for isolating the performance problem by dynamically placing at least one instrumentation hook in the selected application program; and
(B) computer-readable signal bearing media bearing the workload manager.

22. The program product of claim 21 wherein the computer-readable signal bearing media comprises recordable media.

23. The program product of claim 21 wherein the computer-readable signal bearing media comprises transmission media.

24. The program product of claim 21 wherein the process for isolating the performance problem divides a unit of work in the selected application program that uses a disproportionate amount of system resources into a plurality of sub-units and then analyzes the performance of the plurality of sub-units.

25. The program product of claim 24 wherein the process for isolating the performance problem uses an iterative process to divide a sub-unit of work that uses a disproportionate amount of system resources into a plurality of sub-units and then analyzes the performance of the plurality of sub-units.

26. The program product of claim 24 wherein the unit of work is a transaction with API calls to set the bounds of the transaction.

27. The program product of claim 21 wherein the disproportionate amount of resources is determined by comparing current use of resources with the historical performance.

28. The program product of claim 21 wherein the disproportionate amount of resources is determined by comparing current use of resources with the historical performance and a threshold set by a system administrator.

29. The program product of claim 21 wherein the workload manager identifies the performance problem by comparing current performance with a predetermined threshold.

30. The program product of claim 21 wherein the workload manager identifies the performance problem by comparing current performance with a previous performance and an established comparison threshold.

31. The method of claim 21 wherein the workload manager further notifies a software system provider that a provided software application is causing performance problems in a client computer system.
